(19) United States
(12) Patent Application Publication
(10) Pub. No.: US 2019/0263217 A1
(43) Pub. Date: Aug. 29, 2019

(54) VEHICLE CONSOLE ASSEMBLY

(71) Applicant: Ford Global Technologies, LLC, Dearborn, MI (US)

(72) Inventors: Stuart C. Salter, White Lake, MI (US); Wei Xu, Nanjing (CN); Satyanarayana Raju Vemulapati, Westland, MI (US); Diego Elias Ramirez, Livonia, MI (US)

(73) Assignee: Ford Global Technologies, LLC

(21) Appl. No.: 15/905,060

(22) Filed: Feb. 26, 2018

(51) Int. Cl. B60H 1/00

(52) U.S. Cl. CPC B60H 1/008

(57) ABSTRACT

A vehicle overhead console is provided herein. The vehicle overhead console includes a housing operably coupled with a bracket. The bracket is configured to further couple to a headliner. An air-monitoring device is disposed on a first side of the housing. The air-monitoring device draws air from a first side of the housing and exhausts the air on an opposing side of the housing.

### FIELD OF THE INVENTION

The present disclosure generally relates to vehicle consoles, and more particularly, to vehicle overhead consoles within a vehicle cabin.

### BACKGROUND OF THE INVENTION

Overhead consoles are employed in vehicles to provide various functions. For some vehicles, it may be desirable to have an overhead console that houses one or more sensor assemblies.

### SUMMARY OF THE INVENTION

According to one aspect of the present disclosure, a vehicle overhead console is provided herein. The vehicle overhead console includes a housing operably coupled with a bracket. The bracket is configured to further couple to a headliner. An air-monitoring device is disposed on a first side of the housing. The air-monitoring device draws air from a first side of the housing and exhausts the air on an opposing side of the housing.

According to another aspect of the present disclosure, a vehicle overhead console is provided herein. The vehicle overhead console includes a housing configured to couple with a headliner and defining a duct. An air-monitoring device operably coupled with the duct. One or more baffles extending into the duct.

According to yet another aspect of the present disclosure, a vehicle overhead console is provided herein. The vehicle overhead console includes a housing operably coupled with a bracket. A cover is operably coupled with the housing and defines a duct. An air-monitoring device is disposed on a first side of the housing. The air-monitoring device draws air from a first side of the housing and exhausts the air on an opposing side of the housing. A seal is disposed between the air-monitoring device and the duct. A baffle extends into the duct.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a front portion of a vehicle cabin having an overhead console therein, according to some examples;

FIG. 2 is a rear perspective view of the overhead console having a cover attached thereto, according to some examples;

FIG. 3 is a top perspective view of an overhead console housing and an air-monitoring device configured to couple with the overhead console, according to some examples;

FIG. 4 is a cross-sectional view of the air-monitoring device taken along the line IV-IV of FIG. 3, according to some examples;

FIG. 5 is a cross-sectional view of the overhead console having the air-monitoring device taken along the line V-V of FIG. 1, according to some examples; and

FIG. 6 is an enhanced perspective view of area VI of FIG. 5, according to some examples.

### DETAILED DESCRIPTION OF THE PREFERRED EXAMPLES

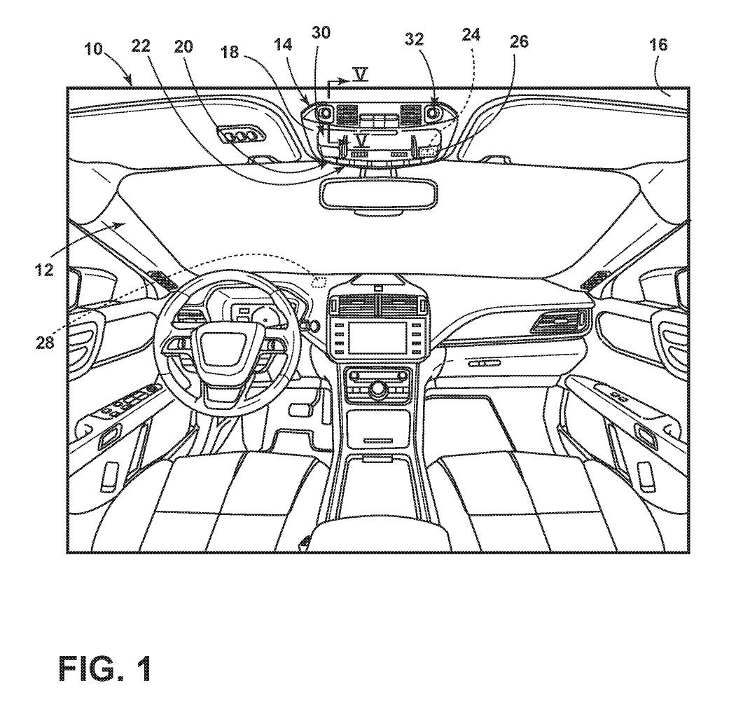

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a console assembly that may be disposed within a vehicle cabin. In some examples, the console may be configured as an overhead console that is disposed above passengers once installed within the vehicle. The console may include one or more air-monitoring devices that detect various air qualities of ambient air within the cabin of the vehicle. In some examples, the ambient air is drawn from the cabin of the vehicle on a first side of the console and/or a headliner and air is exhausted on a second side of the console and/or the headliner.

Referring to FIG. 1, an interior of an automotive vehicle 10 is generally illustrated having a cabin 12 and an overhead console 14 disposed within the cabin 12. The overhead console 14 is assembled to a headliner 16 on an underside of a roof or ceiling of the vehicle cabin 12, generally above a front passenger seating area. It will be appreciated, however, that the overhead console 14 may be disposed in any other location of the vehicle 10 without departing from the scope of the present disclosure.

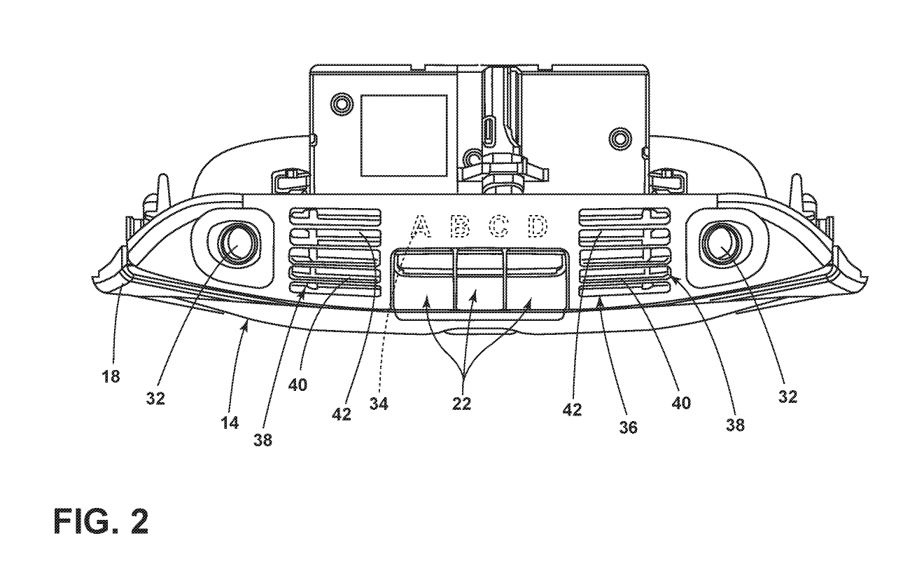

Referring to FIGS. 1 and 2, the overhead console 14 includes a housing 18 that may house a wide range of assemblies. For example, one or more lamp assemblies 20 and/or one or more switches 22 may be disposed in the cavity. The one or more switches may control any of a number of vehicle devices and functions, such as controlling the movement of a sunroof or moonroof, controlling the movement of a moonroof shade, controlling activation of one or more lamp assemblies 20, and various other devices and functions. The switches 22 may include electrical switches in communication with a variety of vehicle systems and in some examples may include biased switches or toggle switches. The lamp assemblies 20 may be configured as interior map/reading lights, dome lights, ambient lights, and/or any other type of light without departing from the scope of the present disclosure. The lamp assemblies 20 may include a light source 24, a reflector, one or more lenses 26, and/or a trim member.

The light source 24 is disposed within the overhead console 14 and is coupled to a circuit board. The circuit board may be secured to and/or within the overhead console 14. The light source 24 may include any form of light source. For example, fluorescent lighting, light-emitting diodes (LEDs), organic LEDs (OLEDs), polymer LEDs (PLEDs), laser diodes, quantum dot LEDs (QD-LEDs), solid-state lighting, a hybrid of these or any other similar device, and/or any other form of lighting may be utilized within the overhead console 14. Further, various types of LEDs are suitable for use as the light source 24 including, but not limited to, top-emitting LEDs, side-emitting LEDs, and others. Moreover, according to various examples, multicolored light sources 24, such as Red, Green, and Blue (RGB) LEDs that employ red, green, and blue LED packaging may be used to generate various desired colors of light outputs from a single light source 24, according to known light color mixing techniques.

The circuit board may be configured as a printed circuit board (PCB) that is operably coupled to a controller 28 including control circuitry including LED drive circuitry for controlling activation and deactivation of the light source 24. The controller 28 may be disposed in the vehicle 10 and/or within the overhead console 14. The circuit board may be configured in any fashion known in the art including, but not limited to, any flexible PCB and/or rigid PCB. The controller 28 may activate the light source 24 based on a plurality of inputs and may modify the intensity of the light emitted by the light source 24 by pulse-width modulation, current control, and/or any other method known in the art. In various examples, the controller 28 may be configured to adjust a color and/or intensity of light emitted from the light source 24 by sending control signals to adjust an intensity or energy output level of the light source 24.

The switches 22 shown in FIGS. 1 and 2 each provide control of a vehicle component or device or provide a designated control function. The one or more of the switches 22 may be dedicated to controlling the movement of a sunroof or moonroof to cause the moonroof to move in an open or closed direction, tilt the moonroof, or stop the movement of the moonroof based upon a control algorithm. One or more other switches 22 may be dedicated to controlling the movement of a moonroof shade between open and closed positions. Each of the moonroof and shade may be actuated by an electric motor in response to actuation of the corresponding switch 22. Other switches 22 may be dedicated to controlling other devices, such as activating/deactivating the lamp assemblies 20, unlocking a trunk, or opening a rear hatch. Additional controls via the switches 22 may include actuating door power windows between open and closed positions. Various other vehicle controls may be controlled by way of the switches 22 described herein.

The overhead console 14 may further include a sunglass bin 30. The sunglass bin 30 may include any form of storage bin, tray, or any other form of compartment configured to provide a selectively accessible storage pocket. In some examples, the sunglass bin 30 may be configured to have an interior portion configured to store glasses, sunglasses, or any other items.

The console housing 18 may further include a hands-free phone assembly. The hands-free phone assembly may include a speaker and/or a microphone 32. The microphone 32 may be a unidirectional microphone or an array of microphones. If the microphone 32 is a unidirectional microphone, the microphone 32 is disposed, for example, in such a manner that the directivity thereof is directed toward the head of a passenger. An array microphone 32 is a microphone in which multiple microphones are arranged close to each other in an array and whose directivity can be directed in any direction by signal processing.

One or more illuminable indicia 34 may also be disposed on the overhead console 14. The indicia 34 may provide any desired information to passengers of the vehicle 10. In some examples, the indicia 34 may be disposed on a backlit film. Each of the indicia 34 may be toggled between an illuminated and an unilluminated state to provide the status of a system that is designated by each respective indicium 34.

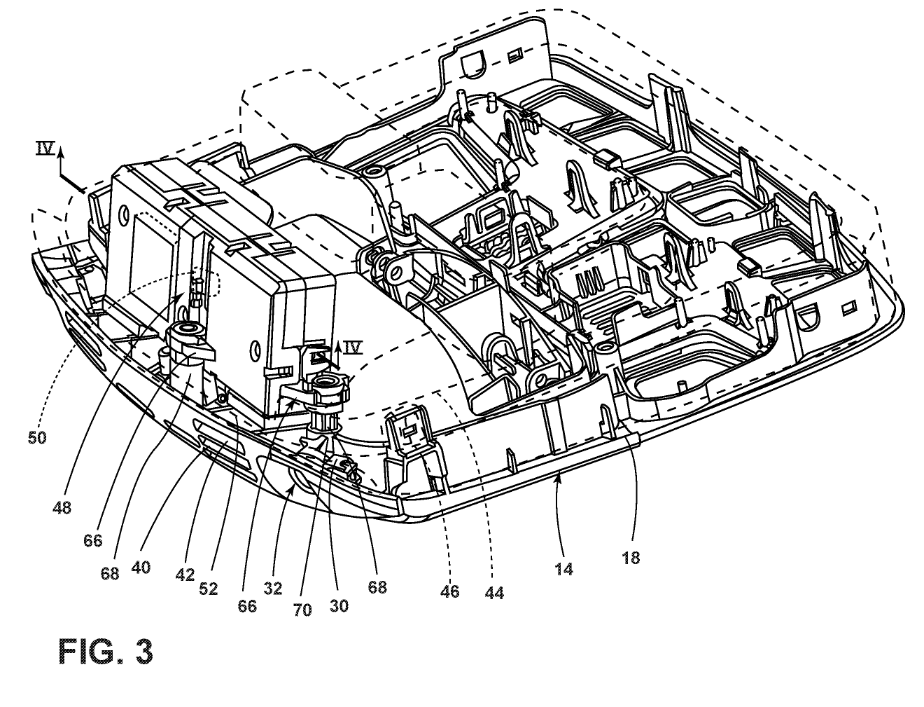

With reference to FIGS. 2 and 3, a cover 36 may be operably coupled with the housing 18. The cover 36 may be coupled to the housing 18 through any method known in the art. In some examples, the cover 36 defines one or more grilles 38. Each grille 38 is provided with grille fins 40 that define the intake ports 42 between the respective grille fins 40. The cover 36 may also define an opening for the microphone 32.

Referring to FIG. 3, the overhead console 14 may include and/or be operably coupled with a bracket 44. The bracket 44 may be in the form of a reinforcement bracket 44 that provides support for the housing 18 in an installed position. Accordingly, the bracket 44 may operably couple with the headliner 16 and the housing 18 may be removably fixed to the bracket 44 to place the housing 18 in an installed position. In some examples, the bracket 44 may include attachment points through which clips and/or retainers 46 on the housing 18 may be inserted. The retainers 46 may be disposed on retainer towers of the housing 18.

One or more ducts 52 may be defined by the cover 36, the housing 18, and/or the bracket 44. The ducts 52 may align with the grilles 38 of the cover 36. In some examples, the cover 36, the housing 18, and/or the bracket 44 may have a first portion formed from a first material, such as a polymeric material having a filler therein and a second portion formed from a second material, which may contain a mixture of polymeric materials. In some examples, the first material may include, but is not limited to, a glass-filled and/or talc-filled polypropylene while the second material may include, but is not limited to, a polyethylene terephthalate and polypropylene mixture. Moreover, in some examples, the first and second materials may have varied sound absorption characteristics.

In some instances, the ducts 52 may be formed from the second material while the remaining portions of the bracket 44 are formed from the first material. According to various examples, the cover 36, the housing 18, and/or the bracket 44 may be formed through a multi-shot molding process. Due to fabrication and assembly steps being performed inside a mold, molded multi-material objects may allow a reduction in assembly operations and production cycle times. Furthermore, the product quality can be improved, and the possibility of manufacturing defects and total manufacturing costs can be reduced. In multi-material injection molding, multiple different materials are injected into a multi-stage mold. The sections of the mold that are not to be filled during a molding stage are temporarily blocked. After the first injected material sets, then one or more blocked portions of the mold are opened and the next material is injected. This process continues until the required multi-material part is created.

According to various examples, a multi-shot molding process is used to create the cover 36. Initially, the ducts 52 of the cover 36 may be formed through a first injection-molding step, or through successive steps, if necessary. The remaining portions of the cover 36 may then be formed in a successive step. In alternative examples, additional components may be added during one of the injection steps, or successively added in additional injections to adhere more components to the cover 36.

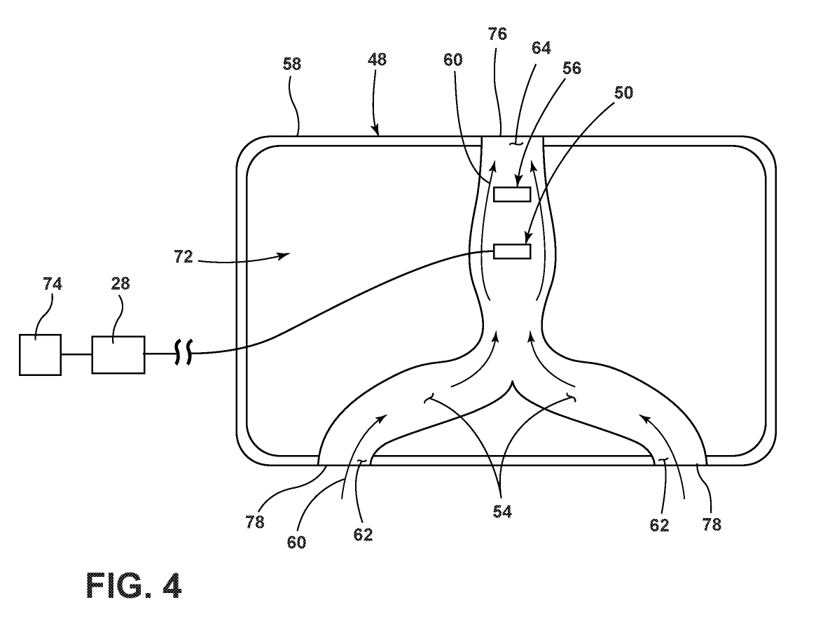

With reference to FIGS. 3 and 4, an air-monitoring device 48 may be operably coupled with the cover 36, the housing 18, and/or the bracket 44. The air-monitoring unit includes an enclosure 58 and a sensor 50 within the enclosure 58 to monitor an air quality within the cabin 12. The air to be sampled is directed from the cabin 12, through the grilles 38, and into the one or more ducts 52. From there, the air from the cabin 12 is directed through chambers 54. The chambers 54 are an air conduit inside the air-monitoring device 48. From the chambers 54, the air is routed to one or more sensors 50. The air may be routed using an airflow actuator device 56, such as a pump, fan, or other such devices. In some instances, the air-monitoring device 48 further includes sensors 50 to measure environmental or air quality parameters, such as temperature, humidity, barometric pressure, or ozone level, which can change after the air enters the air-monitoring device 48. For example, as the air travels through the air-monitoring device 48 the temperature may increase or ozone may react with the walls of the chambers 54, thereby reducing the accuracy of the measurement. These parameters may be measured soon after the air is brought into the air-monitoring device 48.

From the chambers 54, air may be routed to the sensor 50. In some examples, a particle detector may use particle sensing or particle counting technology to determine an amount of particulate matter within the cabin air. Particle sensing systems are based on measuring air parameters that give an indication of the total mass of the particles in the air. Particle counting sensors are used to count the number of particles of a given size and can discriminate between different sized particles.

With further reference to FIGS. 3 and 4, the enclosure 58 includes one or more projections 66 that may correlate with respective standoffs 68 that are attached to the cover 36, the housing 18, and/or the bracket 44. In some examples, the standoffs 68 may be integrally formed with the cover 36, the housing 18, and/or the bracket 44. A fastener 70 may be disposed through the attachment point and secured within the standoff for removably or fixedly coupling the enclosure 58 to the bracket 44. Any type of fastener 70 known in the art may be utilized without departing from the scope of the present disclosure.

With reference to FIG. 4, the air-monitoring device 48 is exemplarily illustrated according to some examples. However, it will be appreciated that any other air-monitoring device 48 may be used within the console 14 without departing from the scope of the present disclosure. As illustrated, the air-monitoring device 48 includes an enclosure 58 defining an interior volume 72. One or more air inlet ports 62 and an air outlet port 64 may be positioned on opposite sides of the enclosure 58 and define an airflow pathway 60 therebetween. The airflow actuator device 56 (such as an air pump, fan, or the like) is configured to generate flowing air through the air inlet port 62, along the airflow pathway 60 through the interior volume 72, and out the outlet port 64. A sensor 50 is positioned along the airflow pathway 60 such that when the airflow actuator device 56 is energized, air is moved by the sensor 50. Sensor circuitry or other components for operation of the sensor are operably coupled with the sensor. The sensor circuitry may provide sensor signals to the controller 28 and may be operably coupled with a power source 74.

According to some examples that include the enclosure 58 and/or the airflow actuator device 56, air flows into an air inlet port 62 in the air-monitoring device 48 because of lower pressure caused by the airflow actuator device 56. Alternately, the airflow actuator device 56 could be placed at the air inlet port 62 to push air through the air-monitoring device 48 because of higher pressure. The air to be sampled enters into the one or more chambers 54 to help define the airflow pathway 60 or, in other examples, the air can generally flow through open space in the interior of the air-monitoring device 48 and then onto and/or past the sensor 50. Air exits past the airflow actuator device 56 and discharges from the air-monitoring device 48 through the outlet port 64, which in some examples may have a cover 76. Likewise, the air inlet port 62 may have a port cover 78. The covers 76, 78 may further minimize noticeable operational noise generated by the air-monitoring device 48 from the cabin 12.

The particle-counting sensor 50 may be configured as a mechanical sensor, an optical sensor, and/or any other sensor capable of detecting an amount and/or size of particulate within the ambient air of the cabin 12. In optical examples, the particulate detector may operate by sending a small high-speed stream of air through the beam of a laser diode. Light that is scattered, reflected, or refracted by any particles in the subject stream of air is collected by various mirrors and optics and then measured by a sensitive light detector. The amount and magnitude of the pulses of light from the detector may then be used to count and sort the sizes of particles in the air stream. Other techniques may also be used to count the quantities of various size particles. Other sensors 50 are available to count ultra-fine particles of size less than 0.1 microns that may be used in conjunction with, or in lieu of, the particle detector described herein. It will be appreciated that any other measurement device may be used for detecting an amount of particulate matter within the cabin 12 without departing from the scope of the present disclosure.

In some examples, the airflow actuator device 56 exhausts the air on an opposing side of the cover 36, the housing 18, and/or the bracket 44 from the inlet port 62. Accordingly, noise generated by the air-monitoring device 48 and/or the airflow actuator device 56 within the air-monitoring device 48 is reduced within the cabin 12, as the exhausted air may be exhausted above the headliner 16. The headliner 16 may be configured as a structure having one or more layers. The one or more layers may have sound attenuation characteristics that minimize the noticeable noise within the cabin 12.

In some examples, additional sensors may be connected to, or placed on or within the device to detect, record, store, and transmit additional data such as air temperature, humidity, relative humidity, and dew point data at the time of the sample and/or during periods of time prior to or following the time sampling is conducted. With this feature, a record over time of such data can be obtained and analyzed.

In some examples of the novel technology, the airflow actuator device 56 in the air sampling air-monitoring device 48 may be adjusted to control the flow of air therethrough, either locally via manual adjustment, locally via electronic controller 28 adjustment, or via remote inputs. In the examples including manual local control of airflow volume per unit of time, the control of airflow may be achieved by a variable potentiometer in series with a power source 74 for the airflow actuator device 56. The potentiometer may be located on a surface of the enclosure 58 or may protrude through a surface of the enclosure 58, such that it can be adjusted without opening the enclosure 58.

Referring still to FIG. 4, the sensor 50 may be coupled to the controller 28, which may be any electrical or electronic device capable of executing computer-executable instructions, for example a microprocessor, microcontroller, programmable or discrete logic elements, programmable array logic (PAL) circuits, programmable fusible link circuitry, dedicated custom processors, or any other electrical or electronic components capable of executing computer-executable instructions. The controller 28 may be in electric communication with a non-transitory computer-readable medium, which may include computer-executable instructions, which may be read and executed by controller 28. The computer-readable medium may be, for example, a semiconductor memory, and may include any number of semiconductor devices. In some examples, the sensor 50 is coupled to the controller 28 by wiring. In other examples, the sensor 50 can be coupled to the controller 28 by a wireless communication protocol, such as a BLUETOOTH® protocol or other wireless protocol as understood by those with ordinary skill in the field of the disclosure. Further, the controller 28 can be coupled to a power source 74, which functions to power the controller 28. In some examples, the power source 74 can also power the air-monitoring device 48 via the wiring. In other examples in which the air-monitoring device 48 is coupled to the controller 28 by a wireless protocol, the air-monitoring device 48 can include its own power source or sources (not shown). The controller 28 can be configured to control the air-monitoring device 48. For example, the controller 28 can include manual input, user-driven programming or other inputs (e.g., as manifested in software, hardware in the form of a printed circuit board (PCB), or the like) that can facilitate individual control of the air-monitoring device 48. In some examples, the controller 28 can adjust the power levels, timing, and activation of the air-monitoring device 48.

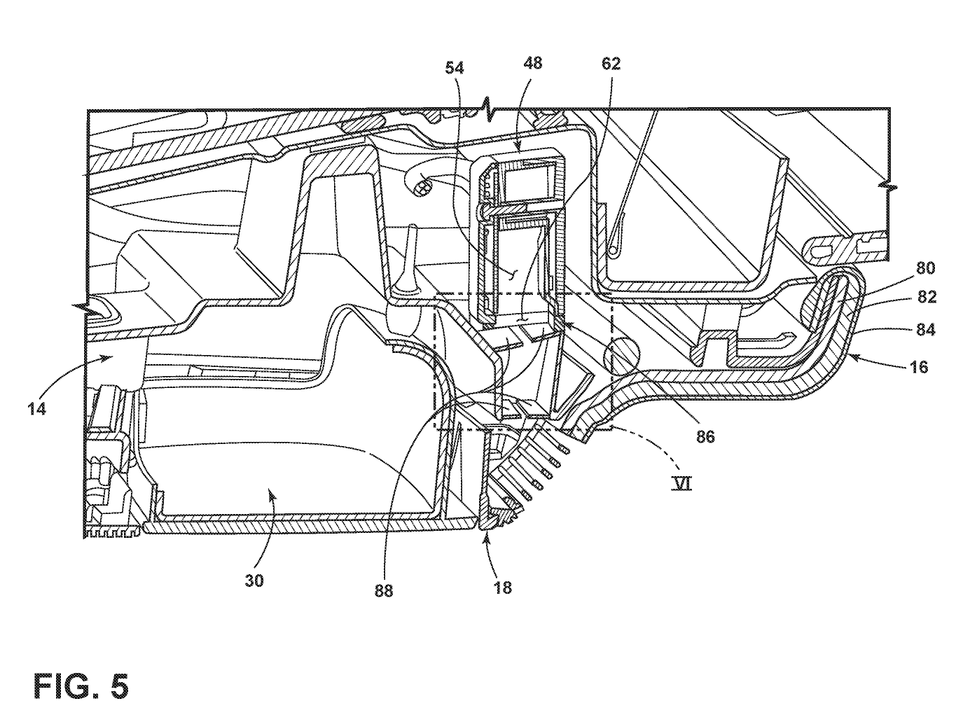

Referring to FIG. 5, when installed within the vehicle 10, the housing 18 may be at least partially surrounded by the headliner 16. The headliner 16 may include a backing panel 80 and a foam panel 82 attached to the backing panel 80. The backing panel 80 may at least partially support the mounting of the overhead console 14. The backing panel 80 can be a polymeric panel, a fiberglass panel, or any other desired material. The backing panel 80 and foam panel 82 may have any desired thickness. According to various examples, the foam panel 82 maintains a substantially uniform thickness along the backing panel 80. Alternatively, the foam panel 82 may have a variable thickness based on the location of the foam panel 82 in relation to other features of the vehicle cabin 12. It is contemplated that the backing panel 80 may be attached to the roof structure through any means known in the art without departing from the teachings provided herein.

The bottom surface of foam panel 82 may be covered with a decorative cover 84, which can be a woven or non-woven fabric, textile, polymeric, and/or elastomeric material. A pattern may be disposed on the cover 84. The pattern may take any form such as a landscape graphic, a natural wood or stone image, a design, a shape or indicia. Further, the pattern may be provided with virtually any color or design and in any level of detail.

In some examples, the bracket 44 is installed within the headliner 16, the housing 18 is operably coupled to the bracket 44 through the one or more retainers 46, and the air-monitoring device 48 is operably coupled to the cover 36, the housing 18, and/or the bracket 44 through one or more fasteners. When is use, air may be moved from a position within the cabin 12 of the vehicle 10 through the grilles 38 of the cover 36, through the ducts 52, and into the chambers 54 of the air-monitoring device 48. Once the air is disposed within the air-monitoring device 48, a quantity of particulate matter is measured through any sensor 50 known in the art. Then, the air is exhausted from the air-monitoring device 48 on the upper side of the cover 36, the housing 18, and/or the bracket 44. Accordingly, air may enter the air-monitoring device 48 from one side of the cover 36, the housing 18, and/or the bracket 44 and be exhausted on an opposing side of the cover 36, the housing 18, and/or the bracket 44, which may decrease the amount of noise within the cabin 12 of the vehicle 10. Additionally, the airflow actuator device 56 within the air-monitoring system may be disposed proximate the outlet port 64 as well. Thus, less noise may be noticed within the cabin 12 while the airflow actuator device 56 is in use.

Referring still to FIG. 5, a seal 86 is disposed between the chambers 54 of the air-monitoring device 48 and the ducts 52. The seal 86 may be configured to minimize noise, vibration, or harshness (NVH) issues when the enclosure 58 is coupled to the overhead console 14. The seal 86 may be structured as a conformal piece on edges of the duct 52 and/or the chambers 54 that is used to reduce air leakage. In some examples, the seal 86 may be formed from an expandable polymer or plastic, and possibly one that is foamable. For instance, materials that may be structural, sealing, sound damping, sound absorbing, sound attenuating or a combination thereof may be utilized, which include, but are not limited to, epoxy-based, acrylate-based or acetate-based foams. In some examples, the seal 86 may include an elastomeric material. The elastomeric material may be silicone rubber and may be vulcanized at the same time during manufacturing or attachment of the seal 86 to the ducts 52 and/or the chambers 54. The seal 86 may be compressed between the ducts 52 and the air-monitoring device 48 to seal any gaps therebetween.

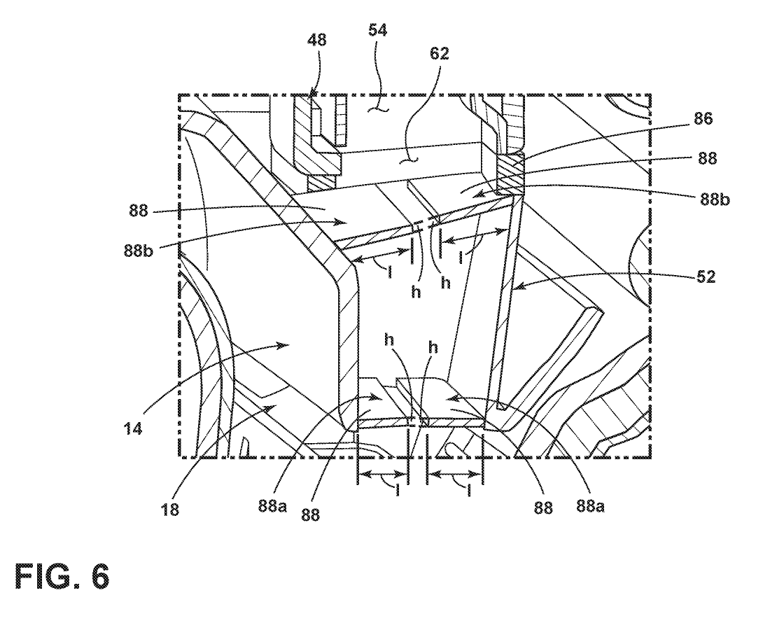

With reference to FIGS. 5 and 6, one or more baffles 88 are disposed within the ducts 52. In some examples, a first pair of baffles 88a may be disposed at an inlet portion of the duct 52 while a second pair of baffles 88b may be disposed on an exit portion of the duct 52. However, it will be appreciated that any number of baffles 88 may be disposed in any portion of the duct 52, or the chambers 54, without departing from the scope of the present disclosure. The baffles 88 may assist in providing a uniform distribution of airflow into the chambers 54. The baffle 88 thus may serve to improve airflow actuator device 56 efficiency by reducing system pressure drop and/or may reduce objectionable noise, such as low-frequency noise.

As illustrated in FIG. 6, each baffle 88 may have a height h and a length l. While each baffle 88 is shown extending a length l into the duct 52, any other positioning of the baffle 88 may be determined by computational fluid dynamics modeling and/or real-world testing of various duct geometries. A desired height h of the baffle 88 may also be determined by simulations or real-world testing. The baffles 88 may create an expansion chamber and/or muffler within the duct 52. In such instances, the width of the ducts 52, or diameter, may be 1.5 times the length of the ducts 52 to assist in sound attenuation within the ducts 52.

With further reference to FIG. 6, the baffles 88 may be constructed out of any suitable material, such as a polymer. In some examples, a multi-layer construction may be employed. For example, an insulator may be positioned on a polymeric base structure to further provide sound dampening. However, in other examples, other constructions may be used such as a single layer of any practicable material without departing from the teachings provided herein.

Various characteristics of the baffles 88 may be tuned to attenuate targeted frequencies. For example, the size (e.g., surface area spanning the openings) and geometry of the baffles 88 may be selected to enable dampening of a desired frequency of frequency range. It will be appreciated that the size of the baffles 88 may be selected to increase the performance of the air-monitoring device 48. The desired acoustic characteristics may include a sound tone and sound level produced by the air-monitoring device 48. Moreover, the size of the baffles 88 as well as other geometric characteristics of the ducts 52 may be selected to reduce NVH in the vehicle cabin 12.

Use of the present disclosure may offer a variety of advantages. For instance, use of the overhead console provided herein may include an air-monitoring device to provide information as to the air quality of the vehicle cabin. The overhead console may attenuate sound produced by the air-monitoring device in a variety of ways. For example, the air-monitoring device may sample ambient air from within the vehicle on a first side of the console or the headliner and exhaust the air on a second opposing side of the headliner. Moreover, a seal may be disposed between the duct of the overhead console and the air-monitoring device that has sound attenuating characteristics. Additionally, the ducts of the overhead console that direct air into the air-monitoring device may be formed from a material that also has sound attenuating characteristics. Thus, the air-monitoring device may monitor the air quality of the vehicle while concealed within the cabin and minimizing noticeable operational noise within the cabin. The air-monitoring device provided herein may be coupled with the overhead console in a unique manner while also reducing the costs of placing the air-monitoring device within the vehicle.

According to one aspect of the present disclosure, a vehicle overhead console is provided herein. The vehicle overhead console includes a housing operably coupled with a bracket. The bracket is configured to further couple to a headliner. An air-monitoring device is disposed on a first side of the housing. The air-monitoring device draws air from a first side of the housing and exhausts the air on an opposing side of the housing. Examples of the vehicle overhead console can include any one or a combination of the following features:
the air-monitoring device is operably coupled with the bracket;
the bracket defines integrally formed ducts that direct air towards an inlet port of the air-monitoring device;
the ducts are formed from a first material and a remaining portion of the bracket is formed from a second, different material;
a seal disposed between the air-monitoring device and the ducts;
a cover operably coupled with the housing and defining one or more grilles, the one or more grilles disposed between a vehicle cabin and the ducts;
the seal is formed from a compressible material having sound attenuation characteristics;
the ducts include one or more baffles therein, the one or more baffles configured to minimize operation noise generated by the air-monitoring device within a vehicle cabin;
the air-monitoring device includes a sensor and an airflow actuator device configured to direct air from a cabin along the sensor;
the sensor is configured to detect particulate matter within the air of the cabin; and/or
the one or more baffles include a first pair of baffles extending into the duct proximate an inlet portion of the ducts and a second pair of baffles extending into the ducts proximate an exit portion of the ducts.

Moreover, a method of measuring a vehicle cabin air quality is provided herein. The method includes operably coupling a housing with a bracket, the bracket configured to further couple to a headliner. The method also includes positioning an air-monitoring device on a first side of the housing. The method further includes drawing air through the air-monitoring device from a first side of the housing and exhausting the air on an opposing side of the housing.

According to another aspect of the present disclosure, a vehicle overhead console is provided herein. The vehicle overhead console includes a housing configured to couple with a headliner and defining a duct. An air-monitoring device operably coupled with the duct. One or more baffles extending into the duct. Examples of the vehicle overhead console can include any one or a combination of the following features:
a seal disposed between the air-monitoring device and the duct;
the duct is formed from a first material and a remaining portion of the housing is formed from a second, different material;
the air-monitoring device includes a sensor for measuring cabin air quality and an airflow actuator device configured to direct air from the cabin along the sensor; and/or
a cover operably coupled with the housing and defining one or more grilles, the grilles disposed between a cabin and the duct.

According to yet another aspect of the present disclosure, a vehicle overhead console is provided herein. The vehicle overhead console includes a housing operably coupled with a bracket. A cover is operably coupled with the housing and defines a duct. An air-monitoring device is disposed on a first side of the housing. The air-monitoring device draws air from a first side of the housing and exhausts the air on an opposing side of the housing. A seal is disposed between the air-monitoring device and the duct. A baffle extends into the duct. Examples of the vehicle overhead console can include any one or a combination of the following features:
the cover defines one or more grilles, the grilles disposed between a vehicle cabin and the duct;
the duct is formed from a first material and a remaining portion of the bracket is formed from a second, different material; and/or
the air-monitoring device includes a sensor for measuring cabin air quality and an airflow actuator device configured to direct air from the cabin along the sensor.

It will be understood by one having ordinary skill in the art that construction of the described invention and other components is not limited to any specific material. Other exemplary examples of the invention disclosed herein may be formed from a wide variety of materials unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable and/or physically interacting components and/or wirelessly interactable and/or wirelessly interacting components and/or logically interacting and/or logically interactable components. Furthermore, it will be understood that a component preceding the term “of the” may be disposed at any practicable location (e.g., on, within, and/or externally disposed from the vehicle) such that the component may function in any manner described herein.

It is also important to note that the construction and arrangement of the elements of the invention as shown in the exemplary examples is illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A vehicle overhead console, comprising:
a housing operably coupled with a bracket, the bracket configured to further couple to a headliner; and
an air-monitoring device disposed on a first side of the housing, wherein the air-monitoring device draws air from a first side of the housing and exhausts the air on an opposing side of the housing.

2. The vehicle overhead console of claim 1, wherein the air-monitoring device is operably coupled with the bracket.

3. The vehicle overhead console of claim 1, wherein the bracket defines integrally formed ducts that direct air towards an inlet port of the air-monitoring device.

4. The vehicle overhead console of claim 3, wherein the ducts are formed from a first material and a remaining portion of the bracket is formed from a second, different material.

5. The vehicle overhead console of claim 3, further comprising:
a seal disposed between the air-monitoring device and the ducts.

6. The vehicle overhead console of claim 5, further comprising:
a cover operably coupled with the housing and defining one or more grilles, the one or more grilles disposed between a vehicle cabin and the ducts.

7. The vehicle overhead console of claim 3, wherein the seal is formed from a compressible material having sound attenuation characteristics.

8. The vehicle overhead console of claim 3, wherein the ducts include one or more baffles therein, the one or more baffles configured to minimize operation noise generated by the air-monitoring device within a vehicle cabin.

9. The vehicle overhead console of claim 1, wherein the air-monitoring device includes a sensor and an airflow actuator device configured to direct air from a cabin along the sensor.

10. The vehicle overhead console of claim 9, wherein the sensor is configured to detect particulate matter within the air of the cabin.

11. The vehicle overhead console of claim 8, wherein the one or more baffles include a first pair of baffles extending into the duct proximate an inlet portion of the ducts and a second pair of baffles extending into the ducts proximate an exit portion of the ducts.

12. A vehicle overhead console, comprising:
a housing configured to couple with a headliner and defining a duct;
an air-monitoring device operably coupled with the duct; and
one or more baffles extending into the duct.

13. The vehicle overhead console of claim 12, further comprising:
a seal disposed between the air-monitoring device and the duct.

14. The vehicle overhead console of claim 12, wherein the duct is formed from a first material and a remaining portion of the housing is formed from a second, different material.

15. The vehicle overhead console of claim 12, wherein the air-monitoring device includes a sensor for measuring cabin air quality and an airflow actuator device configured to direct air from the cabin along the sensor.

16. The vehicle overhead console of claim 12, further comprising:
a cover operably coupled with the housing and defining one or more grilles, the grilles disposed between a cabin and the duct.

17. A vehicle overhead console, comprising:
a housing operably coupled with a bracket;
a cover operably coupled with the housing and defining a duct;
an air-monitoring device disposed on a first side of the housing, wherein the air-monitoring device draws air from a first side of the housing and exhausts the air on an opposing side of the housing; a seal disposed between the air-monitoring device and the duct; and
a baffle extending into the duct.

18. The vehicle overhead console of claim 17, wherein the cover defines one or more grilles, the grilles disposed between a vehicle cabin and the duct.

19. The vehicle overhead console of claim 17, wherein the duct is formed from a first material and a remaining portion of the bracket is formed from a second, different material.

20. The vehicle overhead console of claim 19, wherein the air-monitoring device includes a sensor for measuring cabin air quality and an airflow actuator device configured to direct air from the cabin along the sensor.
